(19) United States
(12) Patent Application Publication
(10) Pub. No.: US 2017/0251522 A1
(43) Pub. Date: Aug. 31, 2017

(54) CONTACT PIN MADE OF COPPER WIRE

(71) Applicant: HIRSCHMANN CAR COMMUNICATION GMBH, Neckartenzlingen (DE)

(72) Inventors: Olaf LAEMMLE, Reutlingen (DE); David SILVA, Nuertingen (DE)

(21) Appl. No.: 15/516,525

(22) PCT Filed: Nov. 6, 2015
(86) PCT No.: PCT/EP2015/075935

§ 371 Date: Apr. 3, 2017

(30) Foreign Application Priority Data
Nov. 6, 2014 (DE) 10 2014 116 159.9

(51) Int. Cl. H05B 1/02; B60S 1/58; H05B 3/84

(52) U.S. Cl. CPC H05B 1/0236; H05B 3/84; B60S 1/586

(57) ABSTRACT

Disclosed is a blocking circuit (1) that is to be connected between an electronic device and a rear window heater in a vehicle and comprises a housing (2) with connecting plugs (3, 4), each of which has a contact partner (7); at least one coil (8) that is in electrical contact with the contact partners (7) is arranged inside the housing (2). The disclosed blocking circuit (1) is characterized in that the contact partner (7) is made of copper or brass.

### CROSS REFERENCE TO RELATED APPLICATIONS

This application is the US-national stage of PCT application PCT/EP2015/075935 filed 6 Nov. 2015 and claiming the priority of German patent application 102014116159.9 itself filed 6 Nov. 2014.

### FIELD OF THE INVENTION

The invention relates to an antiresonant circuit assembly for connection between an electronic device and a rear window heater in a vehicle and has a housing with connecting jacks each having a contact, at least one coil inside the housing and electrically connected with the contacts.

### BACKGROUND OF THE INVENTION

Such antiresonant circuits are connected between the heating conductor of the rear window heater and an electronic device, particularly a power supply of a vehicle (for example, the 12 volt car battery), in order for the coil to prevent interference signals that can come via the power supply lines of the rear window heater from interfering with the high-frequency signals that are also received by conductors connected to the heat conductors of the rear window heater. The electronic device, particularly the power supply of the vehicle, must thus have a high electrical capacity in order to ensure the function of the rear window heater. In case of a control power supply with a voltage of 12 volts, it is quite common that currents of up to 40 to 50 amperes have to be transmitted. In order to be able to realize this electrical capacity, it is necessary that the antiresonant circuit assembly with its coil, its connecting jacks and the associated contacts, as well as the lines leading to and from the antiresonant circuit assembly, are dimensioned accordingly. With regard to the connecting jacks with their contacts, it is known from the prior art that the contacts are made of zinc and produced with a die-casting method. However, with such a zinc die-casting method, there is frequently the risk that imperfections are present in the cast structure. Therefore, the process-related production of contacts (contact pins) without imperfections (particularly shrinkage cavities) is not possible. These imperfections, particularly shrinkage cavities, produce a cross-sectional reduction of the contact (pin cross-section reduction), and as a result, due to the current flow when the rear window heater is activated, the contacts can heat up to approximately 100 to 150 degrees and become a fire hazard. This fire hazard is particularly caused because the housing of the antiresonant circuit assembly is made of plastic and can ignite, or it can cause vehicle components adjacent the antiresonant circuit assembly to also ignite due to this high temperature. The fire hazard due to shrinkage cavities in the contacts produced with zinc die casting is further increased by the fact that not only during normal operation with the activated rear window heater, but particularly also during activation and deactivation of the rear window heater, current peaks can occur that not only cause a heating of the zinc die cast contacts but also become an explosion hazard. The fire hazard also exists afterward, and so such contacts produced with a zinc die-casting method are a great fire hazard in the vehicle.

### OBJECT OF THE INVENTION

The object of the invention is therefore to improve an antiresonant circuit assembly such that the fire hazard is not only greatly reduced but, in all probability, can be completely ruled out. Simultaneously, the costs for such an improved contact must also be reduced.

### SUMMARY OF THE INVENTION

According to the invention, the contacts are made of copper or brass. Those two materials, particularly copper, are advantageous because they have no imperfections, particularly no shrinkage cavities, within their structure because they were not produced by die-casting. Furthermore, high-amp current can be very well transmitted by these materials, and they heat up significantly less than the contacts made by zinc die-casting. These materials are furthermore advantageous because they are well suited for soldering in order to make a connection of the contact within the housing of the antiresonant circuit assembly with the coil or possibly by a conductor trace of a circuit board with the coil.

### BRIEF DESCRIPTION OF THE DRAWING

In the following, these further embodiments are described and explained in more detail with reference to the drawings in which

FIG. 1 is a perspective view of the antiresonant circuit assembly of this invention with the top half of the housing removed;

FIG. 2 is a perspective large-scale view of a contact according to the invention;

FIG. 3 is a perspective large-scale view of a choke coil of this invention;

FIGS. 4 and 5 are perspective views illustrating mounting of the contacts on a circuit board; and

FIG. 6 is an exploded view of a prior-art antiresonant circuit assembly.

### SPECIFIC DESCRIPTION OF THE INVENTION

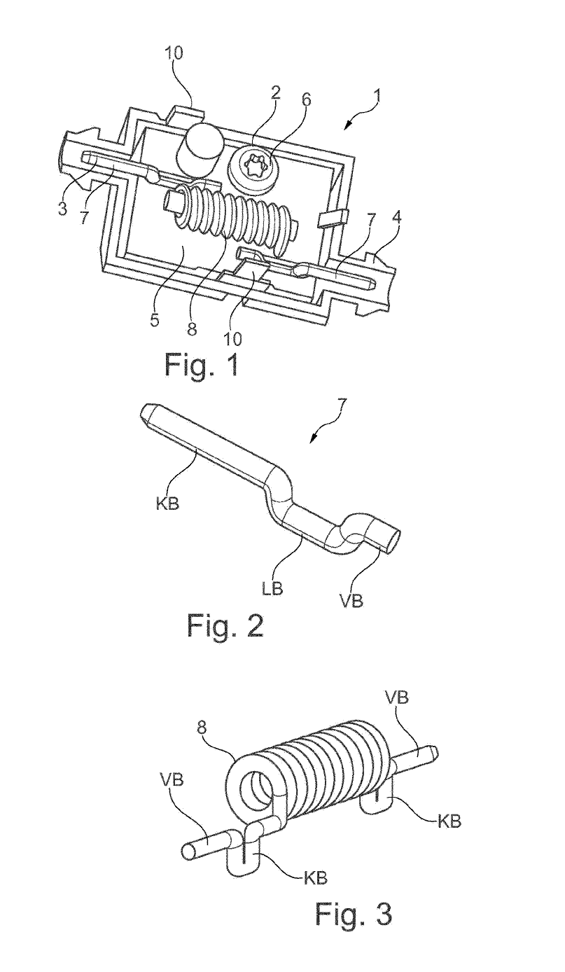

Insofar as shown in detail, FIG. 1 shows an antiresonant circuit assembly 1 having a housing 2 (shown open). Furthermore, the antiresonant circuit assembly 1 has connecting jacks 3, 4. In this case, the jack housing of the connecting jacks 3, 4 is formed by the housing 2, particularly integrally with the housing. The sleeves of the connecting jacks 3, 4 can also be produced as separate components and subsequently be arranged on and fastened to the housing 2.

In the embodiment shown in FIG. 1, a circuit board 5 is in the housing 2. The board 5 preferably consists of a rigid substrate (a flexible substrate is also conceivable), and contact surfaces, conductor traces or the like are present on one or both faces of the board 5 in the contact parts described below. However, a design of the antiresonant circuit assembly 1 is also conceivable with no board 5.

A fastening screw 6 secures the antiresonant circuit assembly 1 to its installation location. The fastening screw 6 can also be used for a ground connection by electrically contacting the antiresonant circuit assembly 1 with corresponding contact surfaces on the board 5 with the ground of the vehicle via the fastening screw 6.

Each of the connecting jacks 3, 4 has a contact 7 that is made of copper or brass. Particularly preferred, the contact 7 has a round cross-section because it is helpful for production, and the plug-in process is thus facilitated when a mating plug is plugged into the corresponding connecting jack 3, 4. If the contact 7 has a round cross-section, it is advantageously made of drawn copper or brass wire. This is also a key advantage because due to the drawing process of copper or brass wire, no influences, such as the already described adverse shrinkage cavities, can form.

A particularly preferred geometric design of the contact 7 is shown in FIG. 2. The contact 7 has a soldering part LB from which a contact part KB is offset parallel, and this contact part KB is in the connecting part of the corresponding connecting jack 3, 4, when the contact 7 is installed as intended.

Alternatively or additionally, a circuit assembly VB is offset parallel from the soldering part LB of the contact 7 and extends toward a circuit assembly of the coil. Basically, the embodiment of the contact shown in FIG. 2 is preferred, as described further below. However, instead of this preferred embodiment, it is also conceivable to have only one angular deflection, even more angular deflections than the ones shown in FIG. 2, or to design the contact 7 so as to extend straight without angular deflection.

FIG. 3 shows by way of example the shape of a coil 8 that has a contact part KB at each end of its helical winding, and a circuit assembly VB adjoining this contact part KB. Other geometric designs of the contact part KB and the circuit assembly VB are also conceivable.

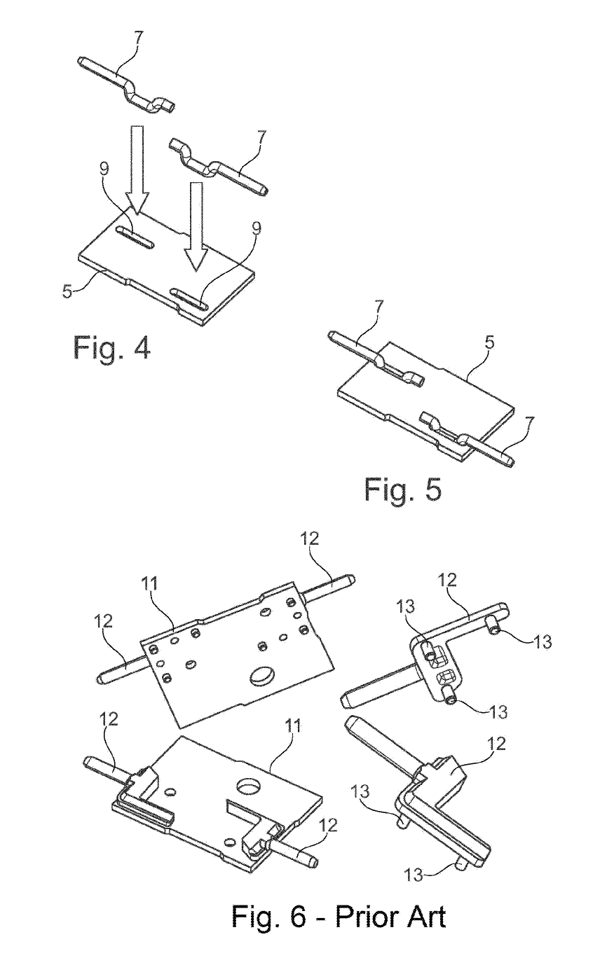

FIG. 4 shows the contacts 7 according to FIG. 2 before being mounted on the board 5. To accommodate the offset design of the soldering part LB of the contact 7, the board 5 has an aperture 9 for each contact 7. On the underside of the board 5, contact parts, particularly around the aperture 9, are present but not shown. Even though not shown in FIG. 4, the board 5 can also have one for aperture for each of the contact parts KB of the coil 8.

FIG. 5 shows that the contacts 7 are, as intended, mounted on or in the board 5. Once again, the coil 8 can be secured by its contact part KB in the board 5.

Once the contacts 7 and the coil 8 are fitted into corresponding aperturees in the board 5, and the soldering parts LB of the contacts 7 and the contact parts KB of the coil 8 project from the underside of the board 5, a subsequent electrical contacting is effected. This electrical contacting can be done by a manual soldering process by soldering together the soldering part LB of the contact 7, the contact part KB of the coil 8, and the surrounding trace on the underside of the board 5. Instead of a manual process, this production process can also be automated by moving the underside of the board 5 with soldering parts LB of the contacts 7 that are installed as intended and slightly projecting from the underside and the contact parts KB of the coil 8 through a solder bath. This type of installation is further advantageous because tolerances can be compensated for after installation, the contact part KB of the contact 7 being positioned accurately in the connecting jacks 3, 4. Furthermore, due to the angular deflection of the contacts 7 between the contact part KB and the soldering part LB, tensile and compression forces can be absorbed during the plug-in process, thus providing tension relief. In addition, due to this offset between the contact part KB and the soldering part LB of the contact 7, vibrations, temperature fluctuations and the like are absorbed.

Instead of the described geometric design of the contacts 7 and the coil 8, it is also conceivable to design these two parts without the soldering part LB of the contact 7 and without the offset contact part KB of coil 8, and to electrically contact the circuit assembly VB of the contact 7 directly with the circuit assembly VB of coil 8. This can be effected edge to edge or executed such that the two connecting parts VB are parallel to one another and are subsequently fitted together, for example, soldered. Crimping or another mechanical immobilization to one another is conceivable for these connecting parts VB. This manner of contacting comes into consideration, for example, when the contacts 7 and the coil 8 are to be installed in the housing 2 of the antiresonant circuit assembly 1 without the use of a board 5.

The contacts 7 can also have a coating at least in their contact part KB, but also extending to the soldering part LB, or also extending to the connecting part VB. The coating can inhibit corrosion particularly in the contact part KB of the contact 7. In addition, the material of the coating and the material of the contact of the mating jack that is plugged into the connecting jacks 3, 4 can be compatible. However, this is only necessary if the contact 7 of the connecting jacks 3, 4 is made of a different material than the contact of the mating jack.

With regard to FIG. 1, it must also be mentioned that the housing 2 used therein is made of several parts. Preferably, exactly two housing parts are used that can be designed so as to be similar or different from one another. In order to increase ease of installation, it is further provided that the at least two parts of the housing 2 are detachably connected to one another by engaging means. FIG. 1 shows by way of example that the engaging means are designed as interengaging latches 10 that interfit with complementary formations with the housing part that are not shown.

FIG. 6 at last shows to some extent an embodiment of a prior-art antiresonant circuit assembly. Such an antiresonant circuit assembly has a board 11 that is provided with contacts 12. These contacts 12 consist of a zinc die cast and have the above-described disadvantages. In addition, these contacts 12 that in this embodiment have three solder feet 13 at their underside, are disadvantageous because the board 11 must be provided with corresponding holes for the solder feet 13, and the installation of the contacts 12 on the board 11 requires a precise positioning process in order to ensure that the downward projecting solder feet 13 fit exactly in the provided holes in the board 12. Therefore, the known contacts 12 made of zinc die cast are not only disadvantageous because they contain shrinkage cavities that can result in fire and explosion hazard but also because they require an elaborate installation effort.

Moreover, the same applies to contacts that are produced by stamping and rolling or a stamping and bending method. For that purpose, a precise manufacturing process is required, and these methods do not result in loadable contacts in order to be able to transmit the energies required for the operation of the rear window heater.

1. An antiresonant circuit assembly for connection between an electronic device and a rear window heater in a vehicle, the assembly comprising:
a housing with connecting jacks, each of which has a contact, and
at least one coil electrically connected with the contacts and inside the housing, the contacts being made of copper or brass.

2. The antiresonant circuit assembly according to claim 1, wherein each contact has a soldering part, from which a contact part that is in a respective one of the connecting jacks, is offset parallel.

3. The antiresonant circuit assembly according to claim 2, wherein a connecting part is offset parallel from the soldering part of the contact and extends toward a circuit assembly of the coil.

4. The antiresonant circuit assembly according to claim 1, further comprising:
a board in the housing with electrically conducting coatings via which the contacts are connected electrically with the coil.

5. The antiresonant circuit assembly according to claim 4, wherein the board has an aperture in which the soldering part of the contact is inserted.

6. The antiresonant circuit assembly according to claim 1, wherein the contact is of round cross-section.

7. The antiresonant circuit assembly according to claim 1, wherein the contact is made of drawn copper or brass wire.

8. The antiresonant circuit assembly according to claim 1, wherein the contact has a coating at least in its contact part.

9. The antiresonant circuit assembly according to claim 1, wherein the housing is formed by several parts.

10. The antiresonant circuit assembly according to claim 9, wherein the parts of the housing are detachably connected to one another by interfitting formations.
